(19) United States
(12) Patent Application Publication
(10) Pub. No.: US 2019/0211854 A1
(43) Pub. Date: Jul. 11, 2019

(54) ADAPTIVE ELASTOMERIC RING FOR USE BETWEEN TWO JOINED COMPONENTS TO RESIST SHEAR MOTION

(71) Applicant: Ford Global Technologies, LLC, Dearborn, MI (US)

(72) Inventor: Gary Nola, Saline, MI (US)

(21) Appl. No.: 15/864,623

(22) Filed: Jan. 8, 2018

(51) Int. Cl. F16B 5/02

(52) U.S. Cl. CPC F16B 5/02

(57) ABSTRACT

A system for fastening a first component to a second component is disclosed. The components may be of the same or may be of different materials although preferably the first component is metal and the second component is formed from a polymerized material. Each component has a fastener bore terminating in a counterbore. When positioned next to one another, the counterbore of the first component faces the counterbore of the second component forming a cavity therebetween. A fastener, such as a threadforming fastener, is provided for attaching the first component to the second component. A sealing gasket is positioned between the components. An elastomeric ring is positioned in one of the two counterbores before attachment. Upon attachment of the two components together using the fastener, the elastomeric member is compressed, thereby causing the member to become deformed to expand laterally to substantially fill the cavity formed by the two counterbores.

### TECHNICAL FIELD

The disclosed inventive concept relates to fastening arrangements for attaching a first component to a second component. More particularly, the disclosed inventive concept relates to a system for fastening two components together comprising a first component having a fastener bore terminating in a counterbore, a second component having a fastener bore terminating in a counterbore, a fastener for attaching the components together, and an elastomeric member positioned in the counterbores. Upon attachment of the two components together using the fastener, the elastomeric member is compressed and expands laterally to substantially fill the cavity formed by the two counterbores. The disclosed system thus resists shear motion between the two attached components.

### BACKGROUND OF THE INVENTION

Common to many industries is the need to attach one component to another component where the components are frequently composed of dissimilar materials. Several methods of attachment are known, including the use of one or more threadforming fasteners. This type of inexpensive fastener is used in, for example, the automotive industry for attaching a metal component, such as a throttle body, to a polymerized component, such as a nylon composite intake manifold. Other uses in the automotive industry may be identified.

This approach, however, has certain known disadvantages that may be easily identified. Referring to FIG. 1, a sectional view illustrating an aluminum throttle body 10 attached to a nylon intake manifold 12 by a threadforming fastener 14 according to a known technique is illustrated. A fastener through hole 16 is formed through the throttle body 10. A gasket 18 is provided between the throttle body 10 and the nylon intake manifold 12.

A characteristic of polymerized material, in this case, nylon, is that it tends to creep. Over time, plastic creep in the throttle body-to-intake manifold joint (containing the gasket to seal the joint) can result in a loss of bolt stretch thereby reducing clamp load as illustrated by the arrow A in FIG. 1. The reduction in clamp load can allow the throttle body 10 to move laterally relative to the intake manifold 12 as illustrated by the arrow B. For a throttle body-to-intake manifold joint containing the joint-sealing gasket, this result is far from ideal. Relative motion can cause damage to the gasket thereby compromising the seal between the throttle body 10 and the intake manifold 12 and thus compromising vehicle performance. Under extreme vibration, the relative motion can be accelerated enough to shear the threadforming fastener 14 and thereby potentially leading to the separation of the throttle body 10 from the intake manifold 12 under certain circumstances.

Recognizing the described deficiency and in an effort to overcome the problems associated therewith, an approach has been taken to prevent shear motion. Illustrated in FIG. 2, a sectional view illustrating an aluminum throttle body 20 attached to a nylon intake manifold 22 by a threadforming fastener 24 according to an alternative technique is illustrated. A gasket 25 is provided between the throttle body 20 and the nylon intake manifold 22. As illustrated, the intake manifold 22 includes a flange or a pin 26 extending from the surface of the intake manifold 22 that is inserted into an aperture 28 formed in the throttle body 20. A fastener through hole 30 is formed through the throttle body 20.

However, this pin-to-hole type of design also suffers from certain limitations. Specifically, the ideal joint will always assemble under an arethmetic tolerance stack-up. This stack-up includes the accumulation of positional and geometrical tolerances of each of the features used. With a single pin 26/hole 28 feature as illustrated in FIG. 2, the total clearance required can be minimized, but still allows for relative motion between the throttle body 20 and the intake manifold 22. This clearance must be less than the clearance between the through hole 30 on the throttle body 20 and the fastener 24 such that the pin 26 will always come into contact with the hole 28 before the throttle body 30 contacts the fastener 24, preventing the possibility of shearing the bolts under aggressive vibration. Also, with a single pin 26/hole 28 feature, translation in the X and Y directions is prevented, but not rotation. For this, multiple pin/hole features are used. This arrangement adds to the tolerance stack-up, increasing the nominal clearance between the pin/hole features. The clearance becomes larger than the clearance between the throttle body 20 and the fastener 24, a situation in which the possibility of shearing the fastener 24 is not prevented.

In an additional approach to solving the known challenges encountered when using a threadforming fastener to attach a throttle body to a nylon intake manifold, “crushable” plastic features have been used. However, these arrangements as well as “designed interference” fits have been shown to create issues with fastener rundown consistency.

Accordingly, known approaches to attaching a metal part, such as an aluminum throttle body, to a part made from a polymerized material, such as a nylon intake manifold, using a threadforming fastener have not provided completely satisfactory results. As in so many areas of vehicle technology, there is always room for improvement related to fastening systems used in the automotive vehicle for attaching a first component to a second component.

### SUMMARY OF THE INVENTION

The disclosed inventive concept provides a system for fastening two components together. The system disclosed herein is a cost-effective and practical solution to the challenges faced when using known arrangements for fastening two components to one another in any of a broad variety of applications.

The components may be of the same or may be of different materials. However, the system is particularly adapted for use in fastening a metal component, such as an aluminum throttle body, to a component composed of a polymerized material, such as an intake manifold. The metal component has a fastener bore terminating in a counterbore and the component made from a polymerized material has a fastener bore terminating in a counterbore. When positioned next to one another, the counterbore of the throttle body faces the counterbore of the intake manifold forming a cavity therebetween.

A fastener, such as a threadforming fastener, is provided for attaching the throttle body to the intake manifold. A sealing gasket is preferably positioned between the throttle body and the intake manifold.

An elastomeric member, such as an elastomeric ring, is positioned in one of the two counterbores. The ring is configured to sit proud of the contact surfaces between the components. Upon attachment of the two components together using the fastener, the elastomeric member is compressed, thereby causing the elastomeric member to become deformed from the initial geometry of its original shape to a deformed geometry wherein the elastomeric member expands laterally to substantially fill the cavity formed by the two counterbores due to the Poisson's ratio of the material. The stiffness and geometry of the elastomeric ring may be tuned to provide the optimal filling of the void between the components and the fastener based on a number of variables, such as but not being limited to the compression distance, the joint geometry, and the positional and geometrical tolerances. The rundown torque traces of the elastomer ring are very consistent, similar to the effect seen on elastomer gasket rundown.

The above advantages and other advantages and features will be readily apparent from the following detailed description of the preferred embodiments when taken in connection with the accompanying drawings.

### BRIEF DESCRIPTION OF THE DRAWINGS

For a more complete understanding of this invention, reference should now be made to the embodiment illustrated in greater detail in the accompanying drawings and described below by way of examples of the invention wherein:

FIG. 1 is a sectional view illustrating an aluminum throttle body attached to a nylon intake manifold by a threadforming fastener according to a known technique;

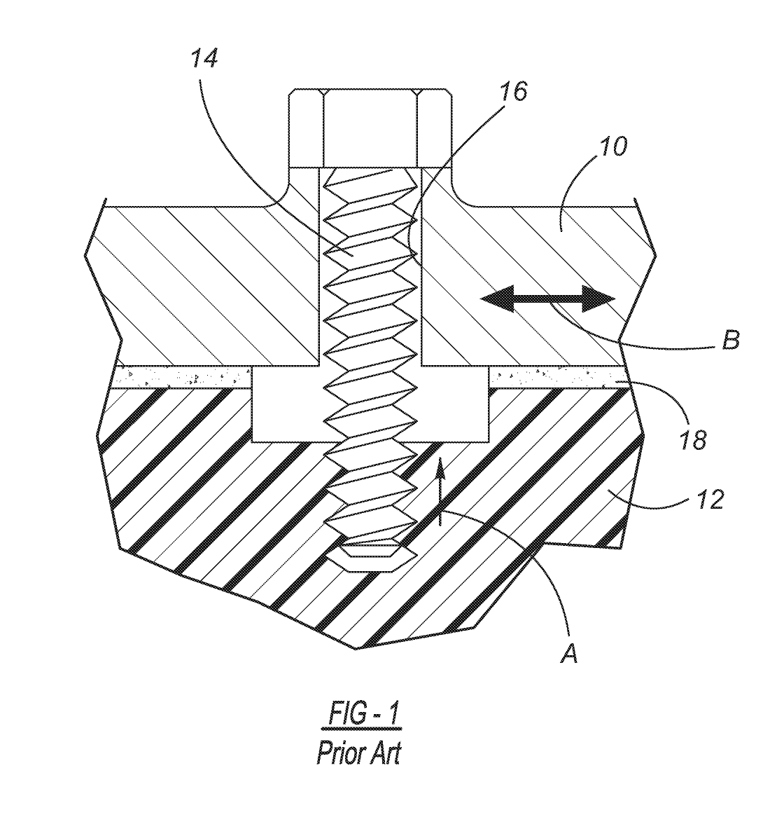

FIG. 2 is a sectional view illustrating an aluminum throttle body attached to a nylon intake manifold by a threadforming fastener according to another known technique;

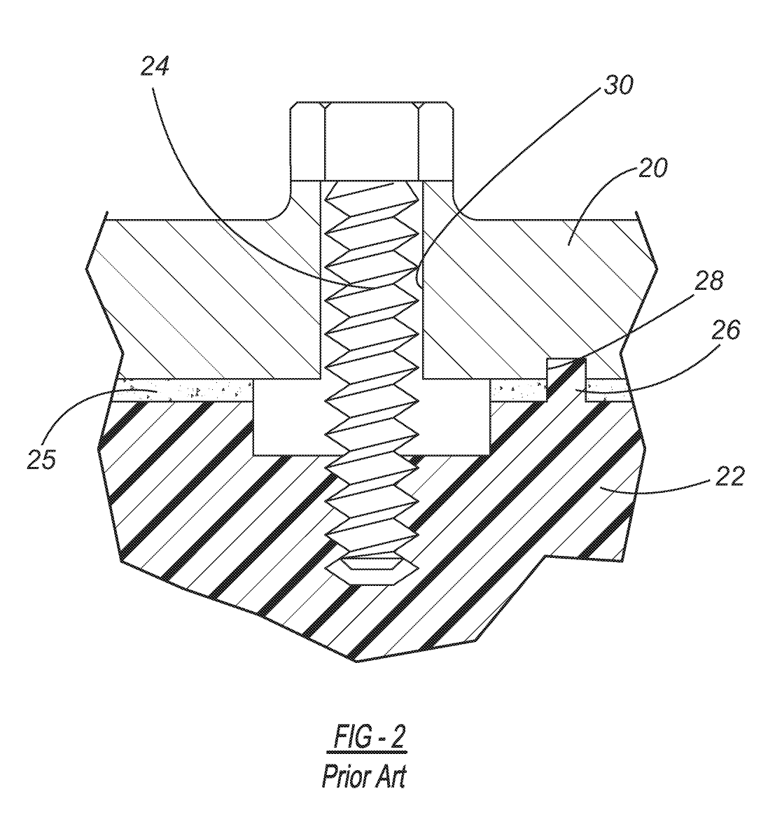

FIG. 3 is a sectional view illustrating an aluminum throttle body about to be attached to a nylon intake manifold by a threadforming fastener system according to the disclosed inventive concept; and

FIG. 4 is a sectional view illustrating an aluminum throttle body after being attached to the nylon intake manifold by the threadforming fastener system of the disclosed inventive concept wherein the top and bottom ends of the elastomeric ring have been compressed thereby forcing the ring to expand laterally to substantially fill the cavity formed between the opposed counterbores.

### DETAILED DESCRIPTION OF THE PREFERRED EMBODIMENT

In the following figures, the same reference numerals will be used to refer to the same components. In the following description, various operating parameters and components are described for different constructed embodiments. These specific parameters and components are included as examples and are not meant to be limiting.

The accompanying figures and the associated description illustrate the fastening system according to the disclosed inventive concept. The embodiment of the disclosed inventive concept is illustrated as being of a certain shape and configuration in which a metal component is attached to a component composed of a polymerized material. It is to be understood that the shapes of the embodiments of the fastening system of the disclosed inventive concept shown in the figures is only illustrative as other shapes may be possible without deviating from the spirit and scope of the disclosed inventive concept.

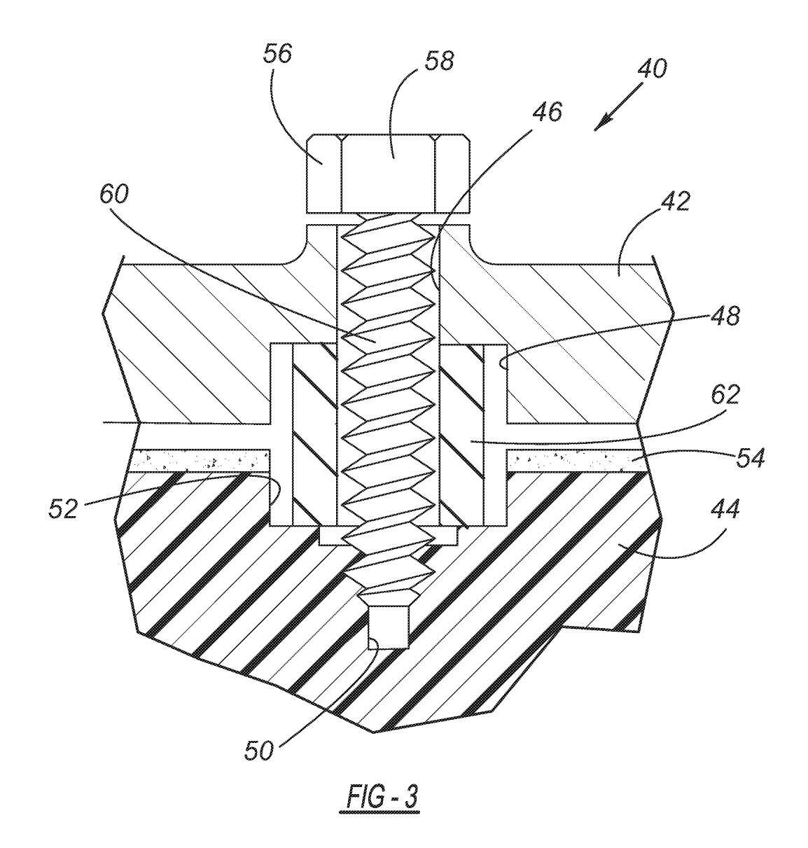

Referring to FIG. 3, a sectional view of a joined throttle body and intake manifold according to the disclosed inventive concept is illustrated. It is to be understood that while a throttle body and an intake manifold are shown, the system of attaching one part to another according to the disclosed inventive concept may be adapted for use in any situation where two components are to be joined and where shear motion needs to be resisted or eliminated entirely. The illustrated joined assembly, generally illustrated as 40, includes a first component 42 positioned in its pre-attached position relative to a second component 44. The first component 42 and the second component 44 may be a composed of one of many possible materials. The first component 42 and the second component 44 may be of the same or may be of different materials. As illustrated, and for purposes of discussion, the first component 42 is a throttle body, preferably made of aluminum, and the second component 44 is an intake manifold, preferably made of a polymerized material such as nylon.

Extending through the first component 42 is a fastener bore 46 that terminates in a counterbore 48. The fastener bore 46 is preferably a smooth bore. Extending through the second component 44 is a fastener bore 50 that terminates in a counterbore 52. The fastener bore 50 may be a smooth bore in which threads are formed if a threadforming fastener is used or may be a threaded bore if a conventional threaded fastener is used. Preferably, the counterbores 48 and 52 are each the same depth and same width.

A sealing gasket 54 is disposed between the first component 42 and the second component 44. The sealing gasket 54 may be formed from any material suitable to the purpose of providing a fluid-tight seal between two components. The sealing gasket 54 includes a fastener-passing hole formed therein.

A threaded fastener 56 is used for fastening the first component 42 to the second component 44. The threaded fastener 56 includes a fastener head 58 and threads 60. Preferably, but not absolutely, the threaded fastener 56 is of the threadforming type.

An elastomeric member 62 is fitted in one of the components 42 and 44 prior to assembly. The elastomeric member 56 may be of any shape but is preferably ring-shaped. The elastomeric member 56 may be made of any of several compressible materials. Non-limiting examples of such materials include nitrile elastomers, EPDM, fluorosilicone, fluoroelastomer, natural and synthetic polyisoprene, neoprene, polyurethane, silicon, and thermoplastic rubber.

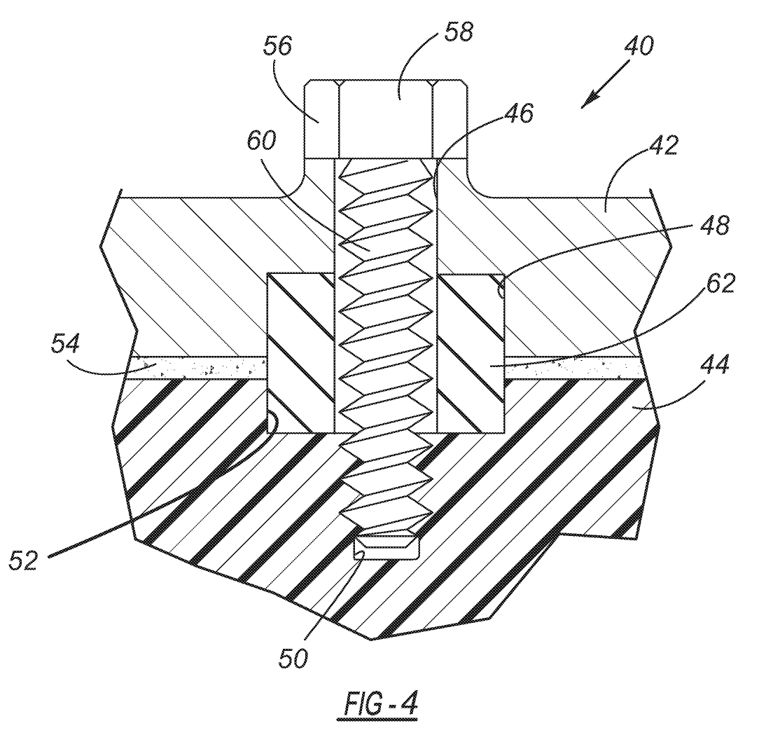

Regardless of the selected material, the elastomeric member 56 is capable of being reshaped from its initial, uncompressed and pre-loaded geometry as illustrated in FIG. 3 to its final, compressed and deformed geometry as illustrated in FIG. 4.

With reference to FIG. 4, a sectional view of a joined assembly 40 is illustrated showing the first component 42 fixedly secured to the second component 44 as a result of the threaded fastener 56 having been threaded into the fastener bore 50. In the case of a non-threaded fastener bore 50 in which a threadforming threaded fastener 56 is used, the threads are formed in the fastener bore 50 during the attachment process.

As the first component 42 and the second component 44 are brought into contact with opposite sides of the sealing gasket 54, the elastomeric member 62 is increasingly compressed, resulting in the elastomeric member 62 being extended laterally until the first component 42 and the second component 44 are brought into fullest possible contact with the sealing gasket 54 and it is not possible to thread the threaded fastener 56 any further. This final condition is illustrated in FIG. 4 in which the elastomeric member 62 has been reformed to its final geometry in which the elastomeric member 62 substantially fills the cavity formed between the counterbores 48 and 52 and where the peripheral wall of the elastomeric member 62 is in full contact with the interior surfaces of the peripheral walls of the counterbores 48 and 52.

In this compressed state, the elastomeric member 62 minimizes or prevents entirely shear motion of the first component 42 relative to the second component 44. The stiffness and geometry of the elastomeric member 62 may be tuned to provide optimal filling of the cavity formed by the counterbores 48 and 52 based on the compression distance, the joint geometry and the positional and geometrical tolerances.

Thus, the disclosed invention as set forth above overcomes the challenges faced by known approaches to attaching a first component to a second component in many applications, but particularly in the automotive setting. The combination of the counterbores 48 and 52 and the use of the elastomeric member 62 provides a relatively low cost solution to the known challenges of providing a desirable connection between components. In addition, the fastening system of the disclosed inventive concept can be readily disassembled and reassembled while re-using the elastomeric component 62, thus minimizing time and cost required for servicing the vehicle. Even with these several advantages in mind, one skilled in the art will readily recognize from such discussion, and from the accompanying drawings and claims that various changes, modifications and variations can be made therein without departing from the true spirit and fair scope of the invention as defined by the following claims.

What is claimed is:

1. A system for fastening two components together comprising:
a first component having a contact side and a fastener bore terminating in a counterbore;
a second component having a contact side and a fastener bore terminating in a counterbore;
a fastener for attaching said components together; and
an elastomeric member positioned in said counterbores, said member having a bore,
whereby shear motion between said components is resisted when said components are attached.

2. The system for fastening two components together of claim 1, wherein said elastomeric member is a ring.

3. The system for fastening two components together of claim 1, wherein said first component is composed of a metal.

4. The system for fastening two components together of claim 1, wherein said second component is composed of a non-metal.

5. The system for fastening two components together of claim 4, wherein said non-metal is a polymerized material.

6. The system for fastening two components together of claim 1, wherein said fastener is a threadforming fastener.

7. The system for fastening two components together of claim 1, wherein said counterbore of said first component is a first counterbore and said counterbore of said second component is a second counterbore, each of said first and second counterbores having a long axis, said long axis of said first counterbore being aligned with said long axis of said second counterbore.

8. The system for fastening two components together of claim 1, further including a gasket between said components.

9. The system for fastening two components together of claim 1, wherein said elastomeric member is a ring having an uncompressed height and an uncompressed diameter and said counterbore of said first component and said counterbore of said second component form a common pocket when said components are fastened together, said pocket having a height and a diameter, said uncompressed height of said ring being greater than said height of said pocket and said uncompressed diameter of said ring being less than said diameter of said pocket.

10. A system for attaching two components comprising:
a first component having a fastener bore;
a second component having a fastener bore, said first and second components being attachable;
a common pocket formed jointly between said components;
an elastomeric member positioned in said pocket, said member having a fastener bore; and
a fastener positioned through said bore of said first component, through said bore of said elastomeric member, and into said bore of said second component.

11. The system for attaching two components together of claim 10, wherein said elastomeric member is a ring.

12. The system for attaching two components together of claim 10, wherein said first component is composed of a metal.

13. The system for attaching two components together of claim 10, wherein said second component is composed of a non-metal.

14. The system for attaching two components together of claim 13, wherein said non-metal is a polymerized material.

15. The system for attaching two components together of claim 10, wherein said fastener is a threadforming fastener.

16. The system for attaching two components together of claim 10, wherein said fastener bore of said first component terminates in a first counterbore and said fastener bore of said second component terminates in a second counterbore, each of said first and second counterbores having a long axis, said long axis of said first counterbore being aligned with said long axis of said second counterbore.

17. The system for attaching two components together of claim 10, further including a gasket between said components.

18. The system for attaching two components together of claim 17, wherein said elastomeric member is a ring having an uncompressed height and an uncompressed diameter and said counterbore of said first component and said counterbore of said second component form a common pocket when said components are fastened together, said pocket having a height and a diameter, said uncompressed height of said ring being greater than said height of said pocket and said uncompressed diameter of said ring being less than said diameter of said pocket.

19. A method for fastening two components together comprising:
forming a first component having a first fastener bore terminating in a first counterbore, a second component having a second fastener bore terminating in a second counterbore, a fastener, and an elastomeric member, each of said counterbores having base wall and a peripheral wall extending from said base wall;
positioning said elastomeric member in said counterbores;
inserting said fastener through said first fastener bore, said first counterbore, said elastomeric member, and said second counterbore and into said second fastener bore;
threading said fastener to draw said components together,
whereby said elastomeric member is expanded by compression against said peripheral walls of said counterbores.

20. The method for fastening two components together of claim 19 wherein said fastener is a threadforming fastener.
